(19) United States
(12) Patent Application Publication
(10) Pub. No.: US 2004/0073460 A1
(43) Pub. Date: Apr. 15, 2004

(54) Method for managing the healthcare of members of a population

(76) Inventor: W. Gary Erwin, Ardmore, PA (US)

Correspondence Address: THOMPSON HINE LLP, 10 W. BROAD ST., SUITE 700, COLUMBUS, OH, 43215-3435, US

(21) Appl. No.: 10/676,516

(22) Filed: Oct. 1, 2003

Related U.S. Application Data
(60) Provisional application No. 60/414,995, filed on Oct. 1, 2002.

(51) Int. Cl. G06F 17/60

(52) U.S. Cl. 705/2

(57) ABSTRACT

A method for managing the healthcare of patients. Key characteristics comprising demographic and medical information are identified for a predetermined population, such as a group of employees. Population data substantially conforming to the key characteristics is then gathered for the members. A set of rules, assumptions and algorithms are established using the population data, accepted medical practices and standards, and formularies. Individual member information may then be analyzed using the rules, assumptions and algorithms to provide the member and/or the member's healthcare providers with recommendations regarding the member's medical care. The member's medical outcome is monitored, and further analysis and revised recommendations may be provided if needed. Medical outcome data may also be used to refine the rules, assumptions and algorithms.

This application claims priority to U.S. Provisional Patent Application 60/414,995, filed Oct. 1, 2002, the contents of which are hereby incorporated by reference.

### FIELD

The present invention relates generally to a method for managing healthcare. More specifically, the present invention relates to a method for managing the healthcare of a population comprising a plurality of members belonging to a class, such as subscribers to a healthcare plan.

### BACKGROUND

A natural byproduct of the aging process is an increasing need for medical care. As they advance in years, many people must undertake a regimen of regular treatment and medication for a variety of diseases and disorders including, but not limited to, cardiovascular diseases and disorders, hypertension, musculoskeletal diseases and disorders, diseases and disorders of the foot, neurologic diseases and disorders, infectious diseases, respiratory diseases and disorders, oral diseases and disorders, gastrointestinal diseases and disorders, endocrine and metabolic disorders, hormone replacement therapy, gynecologic diseases and disorders, disorders of sexual function, hematologic diseases and disorders, oncology renal diseases and disorders, prostate disease, and dermatologic diseases and disorders.

It is not uncommon for medical patients, particularly geriatric patients, to suffer from multiple medical conditions. Such patients frequently visit a number of different medical specialists for treatment. Since medical specialists are not always privy to their patients' complete treatment regimen, and because prescription data may not be adjudicated or otherwise reviewed, there is a risk that these patients may inadvertently incur harm by taking medications for a particular condition that causes an adverse patient reaction when taken in combination with other medications. It has been noted by the healthcare industry that hospital admissions among the elderly due to adverse consequences and therapeutic failures of drug therapy are six times that of the general population.

Of similar concern is the rising cost of employee healthcare benefits. Healthcare benefits are considered by many employers to be a crucial element of an employee benefits package designed to attract and retain talented employees. As a result, healthcare benefits for employees have been available for many years, and at one time were taken for granted. However, the rise of medical technology, pharmacology, research, and escalating medical salaries all began to drive up the cost of medical benefits premiums to the point that the premiums could no longer be sustained by employer groups.

“Managed care” plans were developed in response to the skyrocketing cost of healthcare, to satisfy the desire of employers and others to improve the quality of healthcare while implementing cost controls to maintain the viability of providing healthcare benefits for employees. Under the managed care system, much of the decision-making power is shifted from the healthcare provider to an administrative organization that establishes standards of care, standardizes methods of delivering care, and evaluates the care given. Managed care systems work to control costs through a variety of means, including volume purchases, quality control, formularies, movement of market share, and negotiated fees.

Managed care insurance plans typically contract directly with health-care providers such that the providers receive a set payment for various services, according to a predetermined schedule. Most doctors and hospitals give managed care plans a discount from their standard fees in order to join a provider network and participate in the plan. Managed care plans then offer their subscribers incentives—such as lower out-of-pocket costs—to use the health-care providers who are in the network. Managed care plans also keep costs down by restricting the use of more costly services such as hospital care.

Subscribers to managed care insurance plans are also known as “members” or “participants.” Members receive a defined set of medical benefits in accordance with the terms of the plan. An example managed care plan is an employer-sponsored managed care insurance plan wherein the members may include employees, spouses, and any dependents.

Since managed care systems have as a goal improving the quality of healthcare while controlling cost, there is also a high level of interest within such systems in acquiring as much historical and timely ongoing data as possible regarding such information as the comparative cost and efficacy of various treatment protocols and therapies, members' use of medications and treatments, medical outcomes resulting from the medications and treatments, member demographic information, and various influences on the members' health, such as occupation, family history, and lifestyle.

It must also be recognized that new pharmaceutical and medical treatments are constantly being developed that offer the possibility of an increased life span and/or improved quality of life. However, these new treatments often come with a high price tag, straining the resources of the managed care systems. In addition, as the universe of available drugs and medical treatments expands, the possibility of an unintended result, reaction or drug-drug interaction increases, subjecting the patient to greater health risk. A related problem is the large and growing volume of literature on the efficacy and side effects of prescription drugs, which makes it difficult for physicians to remain current as to the latest pharmacological information. As a result of these issues, some physicians may inadvertently prescribe drugs that are problematic for certain patients.

There is a need to control the cost of healthcare. There is also a need to improve the cost-effectiveness of healthcare. There is a further need for a method to reduce the incidence of avoidable drug interactions. There is a still further need for an improved means for monitoring the effects of new medications and treatments. These needs are of growing importance as the median age of the population continues to rise and the ever-increasing demand for healthcare taxes the continued viability of healthcare resources.

### SUMMARY

The present invention addresses the aforementioned healthcare cost, cost-effectiveness and resource concerns. In addition, the present invention provides a means to check for potential drug-drug interactions, and to monitor the efficacy and side effects of new medications and treatments. The present invention utilizes medical and demographic information gathered from members of a population, such as subscribers to a healthcare plan. The medical and demographic information is analyzed using a set of rules, assumptions and algorithms to provide “outcome-based” suggestions regarding the members' healthcare.

In a method according to an embodiment of the present invention, key member and medical characteristics are first identified, then data substantially conforming to the key characteristics are obtained from a significant proportion of members of the population. The data are accumulated, stored, organized and structured for ease of access. A set of rules, assumptions and algorithms are established, using such criteria and information as accepted medical teachings, standards and protocols, formularies, and the population's member data. The established rules, assumptions and algorithms serve as a tool to facilitate medical analysis. When a particular member requires medical care, the member's medical and demographic information is obtained and analyzed in accordance with the previously-established rules, assumptions and algorithms to arrive at a set of medically-appropriate recommendations for the member. The member's subsequent medical outcome is monitored and recorded, and the results are added to the managed care plan's accumulated data for the member population to continually increase and update the base of available information. Medical outcome data is also used to continually refine the rules, assumptions and algorithms and keep them current with the ever-expanding list of available medications and treatments.

The members' medical data may be stored in a cumulative central repository, allowing the data to be analyzed for potential problems such as drug-drug interactions. In addition, alternate treatments and drug regimens can be identified that may be more compatible with other medications for treating particular diseases and disorders. Similarly, alternate treatments and drug regimens having lower cost but equivalent efficacy can be identified.

A further benefit of outcome-based healthcare is the capacity for predictive and preventative healthcare. With predictive healthcare, members may be monitored for the onset of disorders, diseases, and ailments based on experiences recorded for other members having similar characteristics such as demographics, diseases, disorders, drug regimens, and medical histories. In some cases, cost-effective preventative treatments may be undertaken to potentially delay or circumvent future medical conditions. As a result, members can live longer and/or have a higher quality of life, with an overall reduction in cost to the member and/or the managed healthcare system.

### BRIEF DESCRIPTION OF THE DRAWINGS

Further features of the inventive embodiments of the present invention will become apparent to those skilled in the art to which the embodiments relate from reading the specification and claims with reference to the accompanying drawings, in which:

FIG. 1 is a flow diagram of a method for managing the healthcare of managed care plan members; and

FIG. 2 is a flow diagram of a method of managing the healthcare of a population of managed care plan members.

### DETAILED DESCRIPTION

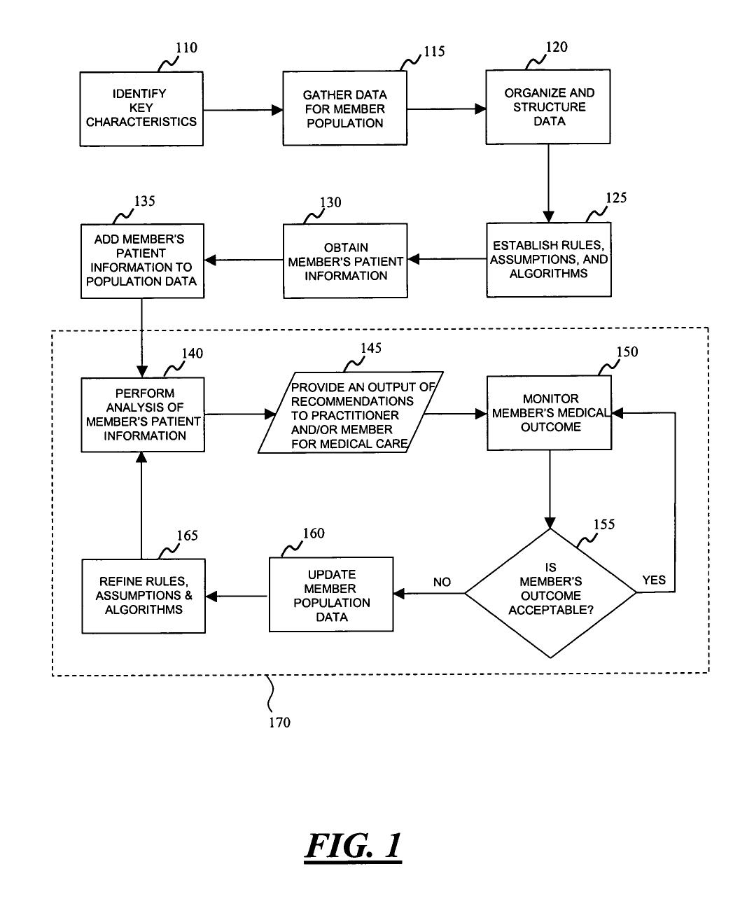

A flow diagram of a method for managing the healthcare of a predetermined population according to an embodiment of the present invention is shown in FIG. 1. The population may be comprised of a plurality of members, the members having at least one common attribute such as membership in a particular managed-care health plan. Beginning with step 110, key characteristics relating to the health of members of the population are identified. Such key characteristics may include, but are not limited to, member demographic information such as vital statistics, occupation, family history, and lifestyle. The key characteristics may also comprise medical information such as medical history, past and present drug regimens, current medical treatments, and responses to treatments and drug regimens. At step 115, “population data” pertaining to the members are gathered from a variety of sources, including, but not limited to, members, plan sponsors such as employers, managed care facilities, clinics, hospitals, and physician's offices. It is preferable that the gathered data be representative of as large a segment of the population as is practical, and include data that substantially conforms to the key characteristics identified at step 110.

Data-gathering step 115 may optionally include de-identification of the data in any conventional manner to achieve compliance with any applicable patient privacy regulations, such as those found in the U.S. Health Insurance Portability and Accountability Act (“HIPAA”). In particular, 45 C.F.R. Parts 160 and 164 of the Act relate to standards for the privacy of individually-identifiable health information (the “Privacy Rule”), promulgated by the Department of Health and Human Services (HHS). In part the Privacy Rule can restrict the acquisition and use of certain types of patient data, particularly individually-identifiable health information. It should be noted that “de-identifying” patient data can entail more than merely redacting the patient's name. This is due to the fact that other patient information such as demographics, medical information, and healthcare facility information could be used separately or in combination to discern the identity of some patients. De-identification thus may involve the deletion or alteration of some portion of patient data to protect patient privacy, while preserving the overall statistical and analytical integrity of the data.

The data gathered at step 115 is stored, ordered and structured in a meaningful way at step 120 to facilitate analysis of the data. An example method of organizing and structuring the data is a conventional computer-based electronic “data warehouse.” A data warehouse is a process by which large quantities of related data from many operational systems is merged into a single, standard repository and organized to provide an integrated information view based on logical queries. Types of logical queries may relate to “data mining,” which may be defined as a process of data selection, exploration and building models using vast data stores to uncover previously unknown patterns.

A set of logical rules, assumptions and algorithms (hereinafter termed “rules”) are established at step 125. The rules are developed using accepted medical teachings, standards, practices and treatment protocols, as well as drawing on the members' data organized and structured at step 120. Development of the rules may also include the use of formularies, data pertaining to the members' medical conditions, and the medical outcomes of treatments and medications associated with the members' medical conditions. In addition, the rules may take into consideration the quality, safety, and cost of various potential treatments. By way of an example, a set of rules may be established to monitor in part for medication side effects such as dizziness and instability of gait, both of which can lead to falls, fractures, disability, hospitalization, and premature death. Such rules may include a set of stratified bone fracture risk categories for members based on such criteria as fracture history, the use of drugs known to increase the risk of fracture, and evidence of osteoporosis treatment. In one such risk category, members who are (a) taking a medication associated with dizziness and falls and (b) have had a previous fracture, but (c) have not been evaluated for osteoporosis, may be categorized as at-risk for osteoporosis.

At step 130 patient information comprising demographic and medical information is gathered for a particular (i.e. selected) member to be treated. This information should substantially include the key characteristics identified at step 110. The member's patient information may be de-identified as detailed above if desired, then added to the accumulated data for the member population at step 135 so as to continually build upon the population data. At step 140, an analysis of the member's patient information is performed using the rules established at step 125. As previously discussed, the rules may draw in part from the histories and medical outcomes of other, similarly-situated members to analyze and assess the member's medical condition and provide suggestions for medical care. The analysis may also consider other factors, such as the potential impact of member demographics on the course of treatment, drug-drug interactions, alternate treatments having better efficacy or reduced expense, the probability and potential impact of side effects, and identification of potential onset disorders and diseases. For example, an analysis at step 140 may indicate that certain drugs should be avoided by particular members due to the drugs' tendency to cause dizziness or instability of gait, which can lead to falls and bone fractures, particularly with geriatric cases. As a further example, recalling the example algorithm of step 125, an analysis of a particular member's patient information at step 140 may indicate that the member may be at risk for osteoporosis, based on the member's patient information.

At step 145 the results of the analysis are output as a set of recommendations for consideration by the selected member's healthcare providers and/or the member. The recommendations may include such suggestions as alternate therapies having greater efficacy or lower cost, preventative treatments, and intervention for onset and/or existing conditions. Continuing the prior example of a member identified as at-risk for osteoporosis, the recommendations of step 145 may include a suggestion that the member undergo a bone mineral density test to check for osteoporosis.

At step 150 the member's subsequent medical outcome, preferably the member's response to the recommended treatment, is monitored. Monitoring may be accomplished by any conventional method, such as follow-up communications with the member and reports from the member's healthcare providers. Data from the monitoring activities of step 150 may be stored in a data repository, such as a data warehouse, for later analysis. The member's response to the recommended treatment of step 145 is then evaluated at step 155. If the member's medical outcome is acceptable, the course of treatment is continued and the member is periodically monitored as at step 150 for any changes in health status, such as long-term medication or treatment effects or the onset of other medical conditions. If at step 155 the desired medical outcome is not achieved, the member's treatment, medical outcome and health status information are added to the accumulated data for the member population at step 160, and may be used at step 165 to update and refine the rules. For example, the member information may indicate that certain medications have more or less efficacy in comparison to alternate medications for the member's medical condition. This information may be used to revise and refine the rules to indicate a correspondingly higher or lower preference for the medication for other similarly-situated members. This process, using regular input from a large number of members, serves to continually refine and update the rules as new medications and treatments are developed. The member is re-evaluated beginning at step 140, using the updated and revised rules of step 165. The revised rules, which take into account the less-than acceptable medical outcome of the member's current medicines and/or treatments and also the experiences of other members may be used at step 140 to address the shortfall in the member's medical outcome. A revised set of recommendations are provided at step 145. This process forms a closed-loop feedback system 170 for medical treatment that is responsive to the needs of particular members, providing medically-appropriate recommendations having high quality.

A number of the steps of the present invention involve the gathering, input and output of data. One skilled in the art will appreciate that these steps may be accomplished at one or more locations, the data being transferred between the locations as needed to accomplish the steps. Example methods of data transfer include telephone, mail, facsimile, and courier. In a preferred embodiment, the data transfer is accomplished by means of an electronic communications network, such as an intranet or the Internet. The use of an electronic communications network facilitates accurate, rapid transmission and reception of data. The electronic communications network preferably includes at least one means of protecting the data in order to ensure member privacy and to prevent third-party interference, such as tampering and alteration. Protection means may include, but are not limited to, password access, partitioning of data, encryption of data, and virtual private networks (“VPNs”). In addition, access to some data, such as patient information, may be restricted to certain pre-determined users of the present invention on a “need to know” basis to protect member privacy. The availability of data may also be partitioned such that various users of the present invention have predetermined levels of access to portions of the data as appropriate for each particular user's need to know in carrying out the present invention.

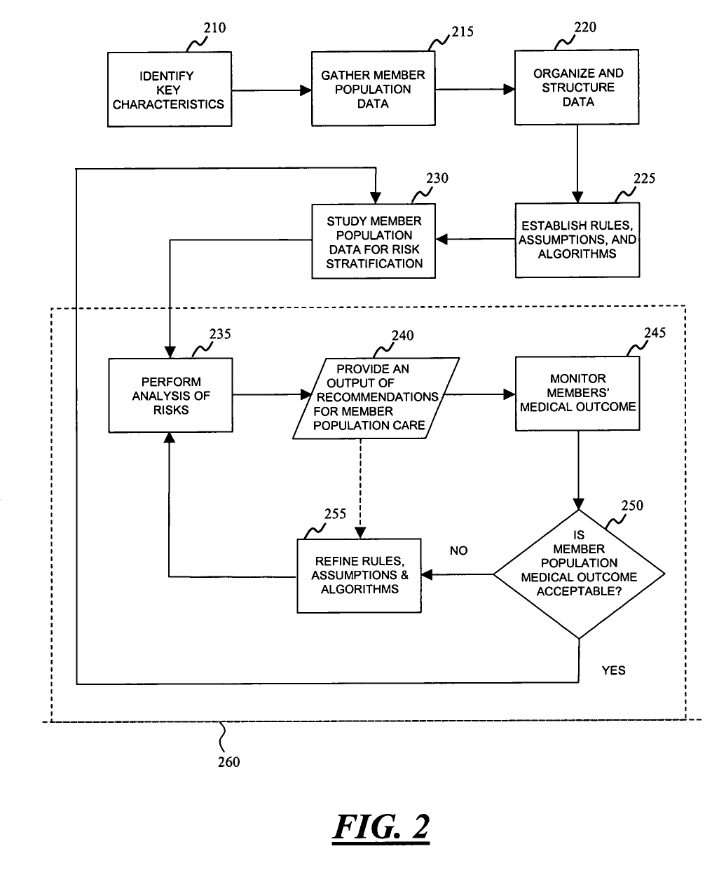

A second embodiment of the present invention is shown in FIG. 2. In this embodiment, data from members of a predetermined population are used to provide recommendations for improving the healthcare outcome for the population as a whole, rather than focusing on the health of individual members. At step 210, key characteristics relating to the health of the members of the population are identified. Key characteristics may include, but are not limited to, demographic information such as vital statistics, family history, occupation, and lifestyle. The key characteristics may also include medical information such as medical history, past and present drug regimens, current medical treatments, and responses to treatments and drug regimens. At step 215, population data comprising key characteristics for the population are gathered from a variety of sources, such as members, plan sponsors, employers, managed care facilities, clinics, hospitals, and physician's offices. The data may be de-identified as discussed above, to protect member privacy. It is preferable that the gathered data be representative of as large a segment of the member population as is practical, and include data that substantially conforms to the key characteristics identified at step 210.

The data is then stored, ordered and structured in a meaningful way at step 220 to facilitate analysis of the data. An example method of organizing and structuring the data is a conventional computer-based electronic “data warehouse,” as described in detail above. A set of logical rules, assumptions, and algorithms (hereinafter referred to as “rules”) similar to those previously discussed are established at step 225 to facilitate data mining. The rules are established by drawing on the members' data of step 220 and applying accepted medical teachings, practices, standards, formularies and protocols. The rules may also take into account the comparative quality, safety, and cost of potential alternate treatments.

At step 230, the data gathered for the population are studied to determine whether any unreasonable health risks to the members are present. For example, the study may include a determination of the most prevalent medical conditions among the members of the population. The identified health risks may be stratified, using any desired criteria to rank the risks in a desired order. For example, the identified health risks may be ranked in order of greatest to least health risk to the members in terms of probability of occurrence or the seriousness of the risk. Similarly, the identified risks may be ranked in order of greatest to least economic impact to the healthcare provider.

At step 235 the member population is analyzed with regard to at least one of the risks identified at step 230. During this step the population data is analyzed using the logical rules established at step 225 to determine root causes for the identified risks. As an example, the study of step 230 may indicate that bone fractures comprise a significant portion of the member population's healthcare needs. The analysis of step 135 may focus on this identified risk to determine root-cause failure mechanisms, such as falls resulting from dizziness or instability of gait due to the side effects of particular medications.

At step 240, an output of recommendations are provided for modifying the healthcare of at least a portion of the member population to reduce the risks identified and analyzed at steps 230, 235 respectively. The recommendations may be provided to healthcare providers and/or directly to the members in any conventional manner, such as newsletters, mass mailings to all members of the population, and mailings to a subset of members identified as being at-risk in an analysis of step 235. Other methods of communication include meetings with members, telephone calls to members, audio and/or video conferencing with groups of members, faxes, and electronic messages such as e-mail messages.

The recommendations of step 240 may include such healthcare changes as switching to medications having fewer (or less severe) side effects, and changing combinations of medications to avoid or minimize adverse drug-drug interactions. The recommendations provided to healthcare professionals may contain suggestions regarding changes in medication and/or treatments, the basis for the suggested changes, and medical and/or pharmacological information to aid the healthcare professionals in making healthcare decisions and carrying out the recommendations. In contrast, recommendations provided directly to members may be in laymen's terms, and may be in the form of suggestions regarding diet, exercise, and lifestyle choices. Recommendations to members may also include suggestions that the member visit their healthcare professional to discuss changing certain medications and/or treatments with a basic rationale for the suggestion (i.e., to save money, reduce dizziness, etc.).

The output of step 240 may also be used to refine the rules as at step 255. Such refinements may include adding or changing rules based on the recommendations to reduce anomalies in the analysis for certain data fact patterns, more accurately identify logical relationships, and ensure that the recommendations are medically appropriate.

The member population is subsequently monitored at step 245 to see if the recommendations provided at step 240 have resulted in a reduction of the risks identified at step 230. If a reduction is seen at step 250, the present invention may be directed toward other identified risks, beginning at step 230 wherein at least one new health risk is identified or selected from an existing set of risks, and subsequent steps 235-260 are performed. If the amount of reduction of the risk among the members is unacceptable, the rules are revised and refined as necessary in step 255 to facilitate more effective analysis of the population and to generate recommendations better targeted toward reducing the identified risk. The process is then repeated, beginning at step 235. This results in a “closed-loop” feedback system 260 for monitoring the member population to continually identify and minimize risks, with the potential for increasing the life span and/or quality of life for members in the population while reducing the cost and resource burden of the healthcare provider. Step 230 may be performed periodically with feedback system 260 to check for new risks and/or changes in the stratification of the identified risks.

With continued reference to FIG. 2, a third embodiment of the present invention may be used to manage the healthcare of particular populations, such as members suffering from a particular medical disorder or disease. For example, the present invention may be utilized to manage healthcare for HIV-positive and AIDS patients. In this embodiment of the present invention, the steps of FIG. 2 are focused on a particular medical condition. For example, step 230 may stratify risks associated with the medical condition, such as risks of contracting the medical condition and risks of various treatments. The present invention may monitor the medical outcome of the population at step 245, track treatment and drug regimens at step 250, refine the rules at 255 in response to medical outcome data as previously detailed, re-analyze the population at step 235 using the revised rules, and recommend changes in treatment protocols and drugs at step 240. The analysis of step 235 and the recommendations of step 240 may take into consideration such factors as each patient's demographic information, medical history, and the stage of the patient's disease. These factors may be compared to the optimum medical outcomes for other similarly-situated members of the population to arrive at recommended treatments and medications.

In a fourth embodiment, the present invention may be used as a tool to carry out a program of predictive and preventative healthcare. As such, the population as a whole may be monitored in order to identify and reduce future risks to the population. Referring again to FIG. 2, the rules of step 225 and study of step 230 may be tailored toward the analysis of risk factors associated with particular medical conditions to identify and stratify the risk of members of the population with regard to the medical conditions. In one example rule, members who have a family history of diabetes, and who meet the criteria of various predetermined physical, occupational and lifestyle risk factors, may be identified as being at-risk for likewise developing the disease. The recommendations of step 240 may include suggestions directed to those risk factors. Similarly, members may be monitored for the onset of disorders, diseases, and ailments based on experiences recorded for other members having similar characteristics such as demographics, diseases, disorders, drug regimens, and medical and family histories. In some cases, preventative and cost-effective treatments may be undertaken which can circumvent more serious afflictions in the member's future. As a result, members can live longer and/or have a higher quality of life, with an overall reduction in cost to the member and/or the managed healthcare system.

As can be seen, the present invention provides a more efficient and accurate means for managing the health of a population, such as a managed care group. The methods provide outputs intended to tailor member care for optimal outcome at a reduced cost and reduced burden to the managed care plan. Further, the present invention can be used to delay or prevent the onset of new disorders and diseases, thereby improving member longevity and quality of life while reducing disability, lost productivity, and the financial burden of the healthcare benefits provider. The present invention may also avert “downstream” healthcare costs by decreasing the use of specific drugs known to increase risk factors such as fractures and cardiac disorders, and by increasing the use of underused therapies proven to avert hospitalizations associated with such conditions as hypertension, heart failure, coronary heart disease, and fractures.

While this invention has been shown and described with respect to a detailed embodiment thereof, it will be understood by those skilled in the art that various changes in form and detail thereof, such as changes in the content, arrangement and order of the various steps of the present invention, may be made without departing from the scope of the claims of the invention.

What is claimed is:

1. A method for managing the healthcare of members of a population, comprising the steps of:
a) identifying key characteristics of the members;
b) gathering population data comprising demographic and medical information of a plurality of the members;
c) organizing, structuring and storing the population data;
d) establishing a set of logical rules based on the population data;
e) obtaining patient specific information of a selected member;
f) analyzing the patient specific information using the logical rules; and
g) providing patient specific recommendations for the medical treatment of the selected member.

2. The method of claim 1, further comprising the step of de-identifying the population data.

3. The method of claim 1, further comprising the step of monitoring the medical treatment outcome of the selected member and assessing whether the treatment outcome is acceptable or not acceptable.

4. The method of claim 3, further comprising the step of periodically monitoring the medical treatment outcome of the selected member using follow-up health checks if the medical treatment outcome of the selected member is acceptable.

5. The method of claim 3, further comprising the steps of:
a) adding the patient specific information and the medical treatment outcome of the selected member to the population data;
b) refining the logical rules based on the selected member's patient specific information and medical treatment outcome;
c) analyzing the patient specific information using the revised logical rules; and
d) providing revised recommendations for the medical treatment of the selected member;
steps (a) through (d) being performed only if the medical treatment outcome of the selected member is unacceptable.

6. A method for managing the healthcare of members of a population, comprising the steps of:
a) identifying key characteristics of the members;
b) gathering population data comprising demographic and medical information of a plurality of members;
c) organizing, structuring and storing the population data;
d) establishing a set of logical rules based on the population data;
e) obtaining patient specific information of a selected member;
f) analyzing the patient specific information using the logical rules;
g) providing patient specific recommendations for the medical treatment of the selected member;
h) monitoring the medical treatment outcome of the selected member;
i) periodically repeating step (h) using follow-up health checks if the medical treatment outcome of the selected member is acceptable; and
j) if the medical treatment outcome of the selected member is unacceptable, performing the steps of:
i) adding the patient specific information and the medical treatment outcome of the selected member to the population data;
ii) refining the logical rules based on the selected member's patient specific information and medical treatment outcome;
iii) analyzing the patient specific information using the revised logical rules; and
iv) providing revised recommendations for the medical treatment of the selected member.

7. A method for managing the healthcare of members of a population, comprising the steps of:
a) identifying key characteristics of the members;
b) gathering population data comprising demographic and medical information of a plurality of the members;
c) organizing, structuring and storing the population data;
d) establishing a set of logical rules based on the population data;
e) studying the population data to establish a stratified set of risks to the members;
f) selecting at least a portion of the set of risks;
g) analyzing the selected portion of the set of risks; and
h) providing recommendations for the medical care of at least a portion of the population.

8. The method of claim 7 wherein the recommendations are used to refine the logical rules.

9. The method of claim 7 wherein the population is comprised of members having a common medical condition.

10. The method of claim 7 wherein the key characteristics, the set of risks and the logical rules are adapted to facilitate predictive healthcare for the members.

11. The method of claim 7 wherein the key characteristics, the set of risks and the logical rules are adapted to facilitate preventative healthcare for the members.

12. The method of claim 7, further comprising the step of de-identifying the population data.

13. The method of claim 7, further comprising the step of monitoring the medical treatment outcome of the population.

14. The method of claim 13, further comprising the steps of
a) selecting a new portion of the set of risks;
b) analyzing the new portion of the set of risks; and
c) providing new recommendations for the medical treatment of the population, if medical treatment outcome of the population is acceptable.

15. The method of claim 13, further comprising the steps of:
a) revising the logical rules;
b) analyzing the selected portion of the set of risks using the revised logical rules; and
c) providing revised recommendations for the medical treatment of the population;
steps (a) through (c) being performed only if the medical treatment outcome of the population is unacceptable.
